(19) United States
(12) Patent Application Publication
(10) Pub. No.: US 2022/0396498 A1
(43) Pub. Date: Dec. 15, 2022

(54) PROCESS FOR PRODUCING A SURFACE-MODIFIED PARTICULATE LITHIUM NICKEL METAL OXIDE MATERIAL

(71) Applicant: JOHNSON MATTHEY PUBLIC LIMITED COMPANY, London (GB)

(72) Inventor: Emilio LOPEZ LOPEZ, Reading, Berkshire (GB)

(21) Appl. No.: 17/755,813

(22) PCT Filed: Nov. 10, 2020
(86) PCT No.: PCT/GB2020/052854

§ 371 Date: May 9, 2022

(30) Foreign Application Priority Data
Nov. 12, 2019 (GB) 1916427.6

(51) Int. Cl. C01G 53/00; H01M 4/36; H01M 4/525

(52) U.S. Cl. CPC C01G 53/66; H01M 4/366; H01M 4/525; C01P 2002/54; C01P 2006/40; C01P 2004/04

(57) ABSTRACT

A process for producing a surface-modified particulate lithium nickel metal oxide material is provided. The process comprises the dry mixing lithium nickel metal oxide particles with at least one metal-containing compound using acoustic energy and then calcining the mixture at a temperature of less than or equal to 800 # C.

### FIELD OF THE INVENTION

The present invention relates to improved processes for making lithium nickel metal oxide materials which have utility as cathode materials in secondary lithium-ion batteries.

### BACKGROUND OF THE INVENTION

Lithium nickel metal oxide materials having a layered structure find utility as cathode materials in secondary lithium-ion batteries. Varying amounts of the nickel in such materials may be substituted with other metals to improve electrochemical stability and/or cycling performance. In the case of lithium nickel metal oxide materials in the form of secondary particles comprising a plurality of primary particles it has also been found that increasing or enriching the amount of certain metal elements at the grain boundary between adjacent primary particles can be an effective way to improve electrochemical performance.

Typically, grain boundary enrichment is achieved by immersion of secondary particles of the lithium nickel metal oxide material in a solution of one or more metal-containing compounds and then removal of the solvent through evaporation, followed by a subsequent heat treatment or calcination step.

For example, WO2013025328 describes a particle including a plurality of crystallites including a lithium nickel metal oxide composition having a layered α-NaFeO₂-type structure, and a grain boundary between adjacent crystallites, wherein a concentration of cobalt in the grain boundaries is greater than in the crystallites. Example 2 of WO2013025328 has the composition Li_{1.01}Mg_{0.024}Ni_{0.88}Co_{0.12}O_{2.03} and has cobalt-enriched grain boundaries. In order to achieve enrichment of the grain boundaries, secondary particles of a lithium nickel metal oxide material are added to an aqueous solution of lithium nitrate and cobalt nitrate and the resulting slurry spray dried before a heat treatment step.

The use of grain boundary enrichment has the drawback that additional process steps are required, leading to higher energy consumption, increased levels of process waste, and higher manufacturing costs. This can impact on the commercial viability of such materials and have environmental impacts.

There remains a need for improved processes for the manufacture of lithium nickel metal oxide materials. In particular there remains a need for improvements in processes which lead to grain boundary enrichment.

### SUMMARY OF THE INVENTION

The present inventors have surprisingly found that immersion of lithium nickel metal oxide particles in a solution of one or more metal-containing compounds is not required to achieve grain boundary enrichment, and that a process involving the use of dry mixing using acoustic energy, in combination with a subsequent calcination at a temperature less than 800° C., can be used to modify the composition at the grain boundaries without the requirement for solvent evaporation. It has further been found that the electrochemical performance of materials produced by immersion-evaporation methods may be at least matched by materials produced by the herein described process, with the advantage that a spray-drying or alternative evaporation step is not required during the manufacturing process, significantly reducing energy consumption and industrial waste.

Accordingly, in a first aspect of the invention there is provided a process for producing a surface-modified particulate lithium nickel metal oxide material having a composition according to Formula 1:

LiₐNiₓM_{y}A_{z}O_{2+b} Formula 1

in which:

M is one or more of Co and Mn;

A is one or more of Al, V, Ti, B, Zr, Cu, Sn, Cr, Fe, Ga, Si, Zn, Mg, Sr, and Ca;

0.8≤a≤1.2

0.5≤x<1

0<y≤0.5

0≤z≤0.2

−0.2≤b≤0.2

x+y+z=1

the process comprising the steps of:

(i) providing lithium nickel metal oxide particles in the form of secondary particles comprising a plurality of primary particles separated by grain boundaries;

(ii) dry mixing the lithium nickel metal oxide particles with at least one metal-containing compound using acoustic energy;

(iii) calcining the mixture at a temperature of less than or equal to 800° C. to form the surface-modified particulate lithium nickel metal oxide material.

In a second aspect, of the invention there is provided surface-modified particulate lithium nickel metal oxide obtained or obtainable by a process described herein.

### BRIEF DESCRIPTION OF THE DRAWINGS

FIG. 1 shows FIB-TEM images of particles of lithium nickel metal oxide material formed in Example 2B showing cobalt grain boundary enrichment.

FIG. 2 shows the results of a C-rate test of the material produced in Example 2A and Example 2B.

FIG. 3 shows the results of cycle life retention testing of the material produced in Example 2A and Example 2B.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The present invention provides a process for the production of surface-modified particulate lithium nickel metal oxide materials having a composition according to Formula I as defined above.

In Formula I, 0.8≤a≤1.2. It may be preferred that a is greater than or equal to 0.9, or 0.95. It may be preferred that a is less than or equal to 1.1, or less than or equal to 1.05. It may be preferred that 0.90≤a≤1.10, for example 0.95≤a≤1.05. In some embodiments a=1.

In Formula I, 0.5≤x<1. It may be preferred that 0.6≤x<1, for example 0.7≤x<1, 0.75≤x<1, 0.8≤x<1, 0.85≤x<1 or 0.9≤x<1. It may be preferred that x is less than or equal to 0.99, 0.98, 0.97, 0.96 or 0.95. It may be preferred that 0.75≤x<1, for example 0.75≤x≤0.99, 0.75≤x≤0.98, 0.75≤x≤0.97, 0.75≤x≤0.96 or 0.75≤x≤0.95. It may be further preferred that 0.8≤x<1, for example 0.8≤x≤0.99, 0.8≤x≤0.98, 0.8≤x≤0.97, 0.8≤x≤0.96 or 0.8≤x≤0.95. It may also be preferred that 0.85≤x<1, for example 0.85≤x≤0.99, 0.85≤x≤0.98, 0.85≤x≤0.97, 0.85≤x≤0.96 or 0.85≤x≤0.95.

M is one or more of Co and Mn. In other words, the general formula may alternatively be written as LiₐNiₓCo_{ya}Mn_{yb}A_{z}O_{2+b}, wherein ya+yb satisfies 0<ya+yb≤0.5, wherein either ya or yb may be 0. Preferably, M is Co alone, i.e. the surface-modified lithium nickel metal oxide preferably contains no Mn.

In Formula 1, 0<y≤0.5. It may be preferred that y is greater than or equal to 0.01, 0.02 or 0.03. It may be preferred that y is less than or equal to 0.4, 0.3, 0.25, 0.2, 0.15, 0.1 or 0.05. It may also be preferred that 0.01≤y≤0.5, 0.02≤y≤0.5, 0.03≤y≤0.5, 0.01≤y≤0.4, 0.01≤y≤0.3, 0.01≤y≤0.25, 0.01≤y≤0.2, 0.01≤y≤0.1 or 0.03≤y≤0.1.

A is one or more of Al, V, Ti, B, Zr, Cu, Sn, Cr, Fe, Ga, Si, Zn, Mg, Sr, and Ca. Preferably, A is at least Mg and/or Al, or A is Al and/or Mg. Where A comprises more than one element, z is the sum of the amount of each of the elements making up A.

In Formula I, 0≤z≤0.2. It may be preferred that 0≤z≤0.15, 0≤z≤0.10, 0≤z≤0.05, 0≤z≤0.04, 0≤z≤0.03, or 0≤z≤0.02. In some embodiments, z is 0.

In Formula I, −0.2≤b≤0.2. It may be preferred that b is greater than or equal to −0.1. It may also be preferred that b is less than or equal to 0.1. It may be further preferred that −0.1≤b≤0.1. In some embodiments, b is 0 or about 0.

It may be preferred that 0.8≤a≤1.2, 0.75≤x<1, 0<y≤0.25, 0≤z≤0.2, −0.2≤b≤0.2 and x+y+z=1. It may be further preferred that 0.8≤a≤1.2, 0.75≤x<1, 0<y≤0.25, 0≤z≤0.2, −0.2≤b≤0.2, x+y+z=1, and M=Co. It may also be preferred that 0.8≤a≤1.2, 0.75≤x<1, 0<y≤0.25, 0≤z≤0.2, −0.2≤z≤0.2, x+y+z=1, M=Co, and A═Mg alone or in combination with one or more of Al, V, Ti, B, Zr, Cu, Sn, Cr, Fe, Ga, Si, Zn, Sr, and Ca. It may also be preferred that 0.8≤a≤1.2, 0.75≤x<1, 0<y≤0.25, 0≤z≤0.2, −0.2≤b≤0.2, x+y+z=1, M=Co alone, and A=Al alone or in combination with one or more of Mg, V, Ti, B, Zr, Cu, Sn, Cr, Fe, Ga, Si, Zn, Sr, and Ca. It may be further preferred that 0.8≤a≤1.2, 0.75≤x<1, 0<y≤0.25, 0≤z≤0.2, −0.2≤b≤0.2, x+y+z=1, M=Co alone, and A=Al and Mg alone or in combination with one or more of Mg, V, Ti, B, Zr, Cu, Sn, Cr, Fe, Ga, Si, Zn, Sr, and Ca.

Typically, the particulate lithium nickel metal oxide material is a crystalline (or substantially crystalline material). It may have the α-NaFeO₂-type structure.

The lithium nickel metal oxide particles are in the form of secondary particles which comprise a plurality of primary particles (made up from one or more crystallites). The primary particles may also be known as crystal grains. The primary particles are separated by grain boundaries.

Typically, the concentration of at least one metal selected from the group of M and A at the grain boundaries of the surface-modified particulate lithium nickel metal oxide material is greater than the concentration of the metal at the grain boundaries of the lithium nickel metal oxide particles prior to the mixing and calcination steps.

The particulate lithium nickel metal oxide material of Formula I is surface-modified. Herein, the term “surface-modified” refers to a particulate material which comprises primary and/or secondary particles which have undergone a surface modification process to increase the concentration of at least one element near to the surface of the particles, i.e. that the particles comprise a layer of material at or near to the surface of the particles which contains a greater concentration of at least one element than the remaining material of the particle, i.e. the core of the particle. The surface modification results from contacting the particles with one or more further metal-containing compounds, and then heating the material. For clarity, the discussions of the composition according to Formula I herein when in the context of surface-modified particles relate to the overall particle, i.e. the particle including the modified surface layer.

Typically, the particulate surface-modified lithium nickel metal oxide material of Formula I comprises enriched grain boundaries, i.e. the concentration of one or more metals in the grain boundaries is greater than the concentration of the one or more metals in the primary particles. The grain boundaries may be enriched with one or more of M or A, for example, cobalt and/or aluminium.

It may be preferred that M includes cobalt and that the concentration of cobalt at the grain boundaries between the primary particles of the surface-modified lithium nickel metal oxide material is greater than the concentration of cobalt in the primary particles of the surface-modified lithium nickel metal oxide material. Alternatively, or in addition, it may be further preferred that the concentration of aluminium at the grain boundaries between the primary particles of the surface-modified lithium nickel metal oxide material is greater than the concentration of aluminium in the primary particles of the surface-modified lithium nickel metal oxide material.

The concentration of cobalt in the primary particles may be at least 0.5 atom %, e.g. at least 1 atom %, at least 2 atom % or at least 2.5 atom % with respect to the total content of Ni, M and A in the primary particle. The concentration of cobalt in the primary particle may be 35 atom % or less, e.g. 30 atom % or less, 20 atom % or less, atom % or less, 15 atom % or less, 10 atom % or less, 8 atom % or less or 5 atom % or less with respect to the total content of Ni, M and A in the primary particles.

The concentration of cobalt in the grain boundaries may be at least 1 atom %, at least 2 atom %, at least 2.5 atom % or at least 3 atom % with respect to the total content of Ni, M, and A in the grain boundaries. The concentration of cobalt in the grain boundaries may be 40 atom % or less, e.g. 35 atom % or less, 30 atom % or less, 20 atom % or less, atom % or less, 15 atom % or less, 10 atom % or less, or 8 atom % or less with respect to the total content of Ni, M and A in the primary particles.

The difference between the concentration of cobalt in the primary particles and in the grain boundaries may at least 1 atom %, e.g. at least 3 atom % or at least 5 atom % (calculated by subtracting the concentration of cobalt in the primary particles in atom % from the concentration of cobalt in the grain boundaries in atom %).

The concentration of a metal, such as cobalt or aluminium, in the grain boundaries and in the primary particles may be determined by energy-dispersive X-ray spectroscopy (EDX) of the centre of a grain boundary and the centre of an adjacent primary particle for a thinly sliced (e.g. 100-150 nm thick) section of a particle by a sectioning technique such as focused ion beam milling.

The particles of surface-modified lithium nickel metal oxide may have a cobalt-rich coating on their surface. The concentration of cobalt in the secondary particles may decrease in a direction from the surface of the secondary particles to the centre of the secondary particles. The difference between the concentration of cobalt at the surface of the secondary particles and in the centre of the secondary particles may be at least 1 atom %, e.g. at least 3 atom % or at least 5 atom % (calculated by subtracting the concentration of cobalt at the surface of the particles in atom % from the concentration of cobalt at the centre of the particles in atom %). The concentration of cobalt may be determined as defined above for the grain boundaries and primary particles.

Alternatively or in addition, the particles of surface-modified lithium nickel metal oxide may have an aluminium-rich coating on their surface. The concentration of aluminium in the secondary particles may decrease in a direction from the surface of the secondary particles to the centre of the secondary particles. The difference between the concentration of aluminium at the surface of the secondary particles and in the centre of the secondary particles may at least 1 atom %, e.g. at least 3 atom % or at least 5 atom % (calculated by subtracting the concentration of aluminium at the surface of the particles in atom % from the concentration of aluminium at the centre of the particles in atom %). The concentration of aluminium may be determined as defined above for the level of cobalt in the grain boundaries and primary particles.

The particles of surface-modified lithium nickel metal oxide typically have a volumetric D50 particle size of at least 1 μm, e.g. at least 2 μm, at least 4 μm or at least 5 μm. The particles of surface-modified lithium nickel metal oxide (e.g. secondary particles) typically have a volumetric D50 particle size of 30 μm or less, e.g. 20 μm or less or 15 μm or less. It may be preferred that the particles of surface-modified lithium nickel metal oxide have a volumetric D50 of 1 μm to 30 μm, such as between 2 μm and 20 μm, or 5 μm and 15 μm. As used herein the volumetric D50 refers to the median particle diameter of the volume-weighted distribution. The volumetric D50 particle size may be determined by using a laser diffraction method (e.g. by suspending the particles in water and analysing using a Malvern Mastersizer 2000).

The process as described herein comprises dry mixing lithium nickel metal oxide particles with at least one metal-containing compound using acoustic energy.

The lithium nickel metal oxide particles are provided in the form of secondary particles comprising a plurality of primary particles. The particles prior to the addition of the coating liquid may be known as the ‘base material’. In some embodiments the particles of the base material have a composition according to Formula (II)

Liₐ₁Niₓ₁M_{y1}A_{z1}O_{2+b1} Formula II

in which:

M is one or more of Co and Mn;

A is one or more of Al, V, Ti, B, Zr, Cu, Sn, Cr, Fe, Ga, Si, Zn, Mg, Sr, and Ca

0.8≤a1≤1.2

0.5≤x1<1

0<y1≤0.5

0≤z1≤0.2

−0.2≤b1≤0.2

x+y+z=1

It may be preferred that A is not Al. In such cases A is one or more of V, Ti, B, Zr, Cu, Sn, Cr, Fe, Ga, Si, Zn, Mg, Sr, and Ca. It may also be preferred that M is Co alone, i.e. that the base material contains no Mn.

It will be understood by the skilled person that the values a1, x1, y1, z1 and b1, and the element(s) A, are selected so as to achieve the desired composition in Formula 1 after the process as described herein.

The base materials are produced by methods well known to the person skilled in the art. These methods involve the co-precipitation of a mixed metal hydroxide from a solution of metal salts, such as metal sulphates, for example in the presence of ammonia and a base, such as NaOH. In some cases, suitable mixed metal hydroxides may be obtainable from commercial suppliers known to the skilled person. The mixed metal hydroxides are then mixed with a lithium-containing compound, such as lithium hydroxide or lithium carbonate, and hydrated forms thereof, prior to a calcination step to form the base material.

It will be understood by the skilled person that the selected metal-containing compound (s) comprise the one or more elements which are desired to be present at an enriched level in the grain boundaries and/or in a surface layer of the surface-modified particulate lithium nickel metal oxide material. The metal-containing compounds are typically metal salts, such as nitrates, sulphates, citrates or acetates. It may be preferred that the metal containing compounds are inorganic metal salts. Nitrates may be particularly preferred.

Preferably, the lithium nickel metal oxide particles are mixed with an aluminium-containing compound. The aluminium-containing compound is typically an aluminium salt, such as an inorganic aluminium salt, for example aluminium nitrate. This can lead to an increase in the concentration of aluminium at the grain boundaries and/or at or near to the surface of the surface-modified lithium nickel metal oxide particles.

Alternatively, or in addition, it is preferred that lithium nickel metal oxide particles are mixed with a cobalt-containing compound. The cobalt-containing compound is typically a cobalt salt, such as an inorganic cobalt salt, for example cobalt nitrate. This can lead to an increase in the concentration of cobalt in the grain boundaries and/or at or near to the surface of the surface-modified lithium nickel metal oxide particles. It may be preferred that the cobalt-containing compound is added in an amount such that the weight percentage of cobalt added is in the range of and including 0.5 to 4.0 wt % of the weight of the lithium nickel metal oxide particles, or more preferably in the range of and including 0.5 to 3.0 wt %, or 0.5 to 2.0 wt %.

Optionally, the lithium nickel metal oxide particles are mixed with a lithium-containing compound, such as a lithium salt, for example lithium nitrate, in addition to at least one other metal containing compound, such as an aluminium-containing compound (such as an aluminium salt) and/or a cobalt-containing compound (such as a cobalt salt). It proposed that this may be beneficial in order to avoid voids or defects in the structure of the surface-modified particulate lithium nickel metal oxide material which may lead to a reduced lifetime.

It may be preferred that the one or more metal-containing compound(s) are provided as hydrates of metal salts, for example a hydrate of a metal nitrate, such as a hydrate of cobalt nitrate and/or aluminium nitrate, optionally in combination with lithium nitrate, or a hydrate of lithium nitrate.

The lithium nickel metal oxide particles are dry mixed with at least one metal-containing compound. As used herein, dry mixing means that the lithium nickel metal oxide particles and the metal-containing compound(s) are mixed as powders without the addition of a solvent, such as water.

The materials are mixed in the presence of acoustic energy. The acoustic energy is applied to a mixing vessel to cause macroscopic and microscopic turbulence within the mixture. The mixing is typically achieved without the use of impellors, blades, rotors, or paddles.

It may be preferred that the mixture is subjected to acoustic energy at a frequency that causes resonance of the materials to be mixed. In this case, the frequency is selected to match the resonant frequency of the mixing vessel and the materials to be mixed. This causes rapid mixing of the lithium nickel metal oxide particles with the or each metal-containing compound.

Typically, the frequency of the acoustic energy applied during mixing is at a much lower frequency than ultrasonic mixing, i.e. it is preferred that the mixing is not ultrasonic mixing. It may be preferred that the acoustic energy applied is in the range from about 15 Hz to about 1000 Hz. It may be further preferred that the frequency range for the acoustic energy is from about 15 Hz to 500 Hz, 15 Hz to 200 Hz, 15 Hz to 100 Hz, 20 Hz to 100 Hz, more preferably 25 Hz to 100 Hz, 30 Hz to 100 Hz, 40 Hz to 100 Hz, 50 Hz to 100 Hz, 50 Hz to 90 Hz, 50 Hz to 80 Hz, 50 Hz to 70 Hz, 55 to 65 Hz, or 58 and 62 Hz.

The level of application of acoustic energy into the mixture is measured in units of acceleration of gravity or “g” (1 g =9.81 m/s²). Typically, the acoustic energy is applied in the range 30 g to 100 g, preferably in a range from 60 g to 100 g, or from 60 g to 90 g. Use of a level of acoustic energy between 30 and 100 g has been found to achieve sufficient mixing of the base material and the or each metal-containing compound without the use of extended mixing times.

The mixing step is typically carried out over a period of between 30 seconds and 10 minutes, preferably between 1 and 10 minutes, more preferably between 1 and 5 minutes.

It may be preferred that the mixing step is performed by applying an acoustic energy in the range of 30 g to 100 g for a period between 30 seconds and 10 minutes,

The acoustic energy may be applied to a mixer configured as a batch mixer or the mixer may be configured to operate in a semi-continuous or continuous manner. It will be understood by the skilled person that if the mixing process is carried out in a semi-continuous or continuous manner the relevant time period for the mixing step is the residence time of the materials to be mixed, and that the residence time is typically between 30 seconds and 10 minutes.

It may be preferable that the mixing step is carried out under a controlled atmosphere, such as an atmosphere free of CO₂ and/or moisture, which may reduce the level of impurities, such as lithium carbonate, in the surface-modified lithium nickel metal oxide particles.

Typically, after mixing, the mixture is subjected directly to the calcination step, without the requirement for additional drying. Advantageously, the mixture may be transferred directly from the mixing vessel to a calciner.

The mixture is then subjected to a calcination step. The calcination step is carried out at a temperature of less than or equal to 800° C. It has been found that higher calcination temperatures may lead to lower grain boundary enrichment and/or a uniform distribution of metal elements within the lithium nickel metal oxide particles.

It may be further preferred that the calcination step is carried out at a temperature less than or equal to 750° C., less than or equal to 740° C., less than or equal to 730° C., less than or equal to 720° C., less than or equal to 730° C., or less than or equal to 700° C. Calcination at a temperature less than 700° C. may lead to improved electrochemical properties, such as a higher discharge capacity.

The calcination step may be carried out at a temperature of at least 400° C., at least 500° C., at least 550° C., at least 600° C. or at least 650° C., for example between 400° C. and 800° C., 400 and 750° C., 500 and 750° C., 550 and 750° C., or 550 and 700° C. The mixture to be heated may be at a temperature of 400° C., at least 500° C., at least 600° C. or at least 650° C. for a period of at least 30 minutes, at least 1 hour, or at least 2 hours. The period may be less than 8 hours.

Preferably, the calcination comprises the step of heating the mixture to a temperature of 400to 800° C. for a period of from 30 mins to 8 hours, more preferably a temperature of 400 to 750° C. for a period of from 30 mins to 8 hours, even more preferably a temperature of 400 to 750° C. for a period of from 30 mins to 6 hours.

More preferably, the calcination comprises the step of heating the mixture to a temperature of 600 to 800° C. for a period of from 30 mins to 8 hours, more preferably a temperature of 600to 750° C. for a period of from 30 mins to 8 hours, or even more preferably a temperature of 600 to 750° C. for a period of from 30 mins to 4 hours.

The calcination step may be carried out under a CO₂-free atmosphere. For example, CO₂-free air may be flowed over the materials during heating and optionally during cooling. The CO₂-free air may, for example, be a mix of oxygen and nitrogen. Preferably, the atmosphere is an oxidising atmosphere. As used herein, the term “CO₂-free” is intended to include atmospheres including less than 100 ppm CO₂, e.g. less than 50 ppm CO₂, less than 20 ppm CO₂ or less than 10 ppm CO₂. These CO₂ levels may be achieved by using a CO₂ scrubber to remove CO₂.

It may be preferred that the CO₂-free atmosphere comprises a mixture of O₂ and N₂. It may be further preferred that the mixture comprises N₂ and O₂ in a ratio of from 5:95 to 90:10, for example from 50:50 to 90:10, or from 60:40 to 90:10, for example about 80:20.

The process may include one or more milling steps, which may be carried out after the calcination step. The nature of the milling equipment is not particularly limited. For example, it may be a ball mill, a planetary ball mill or a rolling bed mill. The milling may be carried out until the particles reach the desired size. For example, the particles of the surface-modified lithium nickel metal oxide material may be milled until they have a volume particle size distribution such that the D50 particle size is at least 5 μm, e.g. at least 5.5 μm, at least 6 μm or at least 6.5 μm. The particles of surface-modified lithium nickel metal oxide material may be milled until they have a volume particle size distribution such that the D50 particle size is 15 μm or less, e.g. 14 μm or less or 13 μm or less.

The process of the present invention may further comprise the step of forming an electrode (typically a cathode) comprising the surface-modified lithium nickel metal oxide material. Typically, this is carried out by forming a slurry of the surface-modified lithium nickel metal oxide material, applying the slurry to the surface of a current collector (e.g. an aluminium current collector), and optionally processing (e.g. calendaring) to increase the density of the electrode. The slurry may comprise one or more of a solvent, a binder, carbon material and further additives.

Typically, the electrode of the present invention will have an electrode density of at least 2.5 g/cm³, at least 2.8 g/cm³ or at least 3 g/cm³. It may have an electrode density of 4.5 g/cm³ or less, or 4 g/cm³ or less. The electrode density is the electrode density (mass/volume) of the electrode, not including the current collector the electrode is formed on. It therefore includes contributions from the active material, any additives, any additional carbon material, and any remaining binder.

The process of the present invention may further comprise constructing a battery or electrochemical cell including the electrode comprising the surface-modified lithium nickel metal oxide material. The battery or cell typically further comprises an anode and an electrolyte. The battery or cell may typically be a secondary (rechargeable) lithium (e.g. lithium ion) battery.

The present invention will now be described with reference to the following examples, which are provided to assist with understanding the present invention and are not intended to limit its scope.

### EXAMPLES

### Example 1

### Example preparation of lithium nickel metal oxide base material (Li_{1.03}Ni_{0.91}Co_{0.08}Mg_{0.01}O₂, Base Material A)

Ni_{0.91}Co_{0.08}Mg_{0.01}(OH)₂ (100 g, Brunp) and LiOH (26.3 g) were dry mixed in a poly-propylene bottle for 1 hour. The LiOH was pre-dried at 200° C. under vacuum for 24 hours and kept dry in a purged glovebox filled with dry N₂.

The powder mixture was loaded into 99%+alumina crucibles and calcined under CO₂-free air. Calcination was performed as follows: to 450° C. (5° C./min) with 2 hours hold, ramp to 700° C. (2° C./min) with a 6 hour hold and cooled naturally to 130° C. The CO₂-free air was flowed over the powder bed throughout the calcination and cooling. The title compound was thereby obtained.

The samples were then removed from the furnace at 130° C. and transferred to a high-alumina lined mill pot and milled on a rolling bed mill until D₅₀ was between 9.5 and 10.5 μm.

### Example 2

### Method of Producing a Surface-Modified Lithium Nickel Metal Oxide Material Example 2A

Base material A (100 g) was placed into a plastic container with cobalt (II) nitrate hexahydrate (11.83 g), aluminium nitrate nonahydrate (2.44 g) and lithium nitrate (1.88 g). The materials were mixed using a LabRAM® resonant acoustic mixer for 1 minute at 40 g operating at 58-62 Hz. The mixed powder was then transferred to a static furnace and calcined in CO₂-free air using a temperature profile of (i) heating to 450° C. at a rate of 5° C./min; (ii) 450° C. for I hour; (iii) heating to 700° C. at a rate of 2° C./min; (iv) 700° C. for 2 hours; (v) allow to cool to ambient temperature.

ICP-MS analysis indicated that the material formed has a composition of Li_{1.01}Ni_{0.867}Co_{0.115}Mg_{0.012}Al_{0.006}O2

X-ray powder diffraction (XRD) of the material produced showed crystalline material with a layered α-NaFeO₂-type structure. The XRD pattern matched previous samples of the same composition produced by an immersion-spray drying method.

### Example 2B

The experiment Example 2A was repeated with the same experimental conditions except that acoustic energy was applied for 5 minutes at 60 g.

ICP-MS analysis indicated that the material formed has a composition of Li_{1.01}Ni_{0.867}Co_{0.115}Mg_{0.012}Al_{0.006}O2

X-ray powder diffraction (XRD) of the material produced showed crystalline material with a layered α-NaFeO₂-type structure. The XRD pattern matched previous samples of the same composition produced by an immersion-spray drying method.

The sample was also analysed by FIB-TEM (Focussed Ion Beam-Transmission Electron Microscopy). Samples were mounted on conductive carbon tab within a glove box, and transferred to the FIB using the transfer shuttle. The samples were prepared using a focused ion beam instrument with a gallium ion beam at 30 kV. Final polishing was performed at 5 kV. The samples were examined in the JEM 2800 (Scanning) Transmission Electron Microscope using the following instrumental conditions: Voltage (kV) 200; C2 aperture (um) 70 and 40; Dark-field (Z-contrast) imaging in scanning mode using an off-axis annular detector. Compositional analysis was carried out by X-ray emission detection (EDX) in the scanning mode.

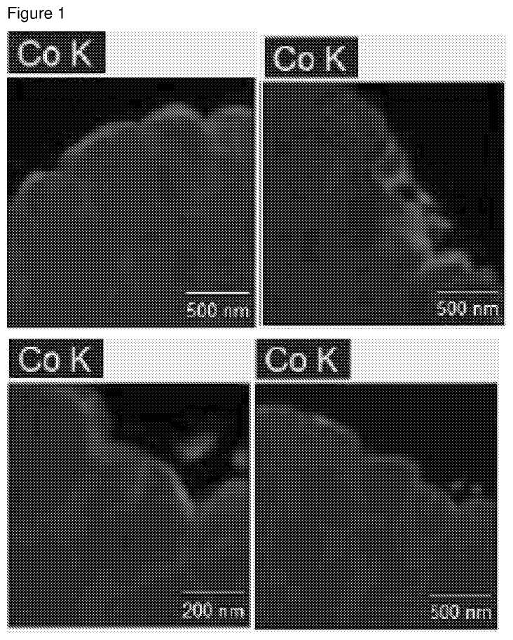

This analysis indicated that there was cobalt enrichment at the particle surface and at the grain boundaries (FIG. 1).

### Example 3

### Variation in Acoustic Mixing Conditions

A further study was carried out using a variety of acoustic mixing conditions. For each experiment base material A (100 g) was placed into a plastic container with cobalt (II) nitrate hexahydrate (11.83 g), aluminium nitrate nonahydrate (2.44 g) and lithium nitrate (1.88 g) and the mixture subjected to acoustic mixing using a LabRAM mixer operating at 58-62 Hz and the conditions shown in Table 1 below.

The mixture was then placed into saggars with a bed loading of 1.4 g/cm², and calcined using an 80% N₂/20% O₂ atmosphere at a gas flow rate of 1 L/min per saggar, and a temperature profile of (i) heating to 130° C. at a rate of 5° C./min; (ii) 130° C. for 5.5 hours; (iii) heating to 450° C. at a rate of 5° C./min; (iv) 450° C. for 1 hour; (v) heating to 700° C. at a rate of 2° C./min; (vi) 700° C. for 2 hours; (vii) allow to cool to ambient temperature.

TABLE 1
Mixing parameters

| Sample | Acceleration (g) | Mixing time (min) |
|---|---|---|
| 3A | 80 | 3 |
| 3B | 40 | 3 |
| 3C | 60 | 5 |
| 3D | 80 | 7 |
| 3E | 40 | 7 |

### Example 4

### Dry Mixing Base Material in the Absence of Acoustic Energy (Comparative Example)

A base material of formula Li_{1.03}Ni_{0.90}Co_{0.08}Mg_{0.02}O₂ (500 g) was—loaded into a Winkworth Mixer model MZ05 and heated to 60° C. with the mixer running at 50 rpm. A mixture of cobalt (II) nitrate hexahydrate (59.0 g, ACS, 98-102%, from Alfa Aesar), aluminium nitrate nonahydrate (12.2 g, 98% from Alfa Aesar) and lithium nitrate (16.4 g, anhydrous, 99%, from Alfa Aesar) was then added and the mixer left to run before discharging the sample. Approximately 250 g of the mixed powder was added to an alumina crucible. The sample was then calcined in a Carbolite Gero GPC1200 furnace with CO₂ free air supplied from a scrubber. The sample was calcined by heating at 5° C./min to 450° C., 1 hour hold at 450° C., heating at 2° C./min to 700° C., 2 hour hold at 700° C., cool to RT with 4 ml/min flow rate of CO₂ free air.

### Example 5

### Method of producing a surface-modified lithium nickel metal oxide material of Formula Li_{1.09}Ni_{0.867}Co_{0.115}Mg_{0.012}Al_{0.006}O₂

The following experiment was repeated three times (Examples 5A to 5C) to examine the reproducibility of the process conditions.

Base material A (50 g) was placed into a plastic container with cobalt (II) nitrate hexahydrate (5.91 g, 2.4 wt % Co), aluminium nitrate nonahydrate (1.22 g) and lithium nitrate (0.94 g). The materials were mixed using a LabRAM (RTM) resonant acoustic mixer for 3 minutes at 80 g operating at 58-62 Hz. The mixed powder was then transferred to a static furnace and calcined in CO₂-free air using a temperature profile of (i) heating to 450° C. at a rate of 5° C./min; (ii) 450° C. for 1 hour; (iii) heating to 700° C. at a rate of 2° C./min; (iv) 700° C. for 2 hours; (v) allow to cool to ambient temperature.

ICP-MS analysis indicated that the material formed has a composition of Li_{1.01}Ni_{0.867}Co_{0.115}Mg_{0.012}Al_{0.006}O₂

X-ray powder diffraction (XRD) of the material produced showed crystalline material with a layered α-NaFeO2-type structure.

### Example 6

### Method of Producing a Surface-Modified Lithium Nickel Metal Oxide Material of Formula Li_{1.01}Ni_{0.867}Co_{0.115}Mg_{0.012}Al_{0.006}O₂

Base material A (50 g) was placed into a plastic container with cobalt (II) nitrate hexahydrate (3.01 g, 1.2 wt % Co), aluminium nitrate nonahydrate (1.22 g) and lithium nitrate (0.94 g). The materials were mixed using a LabRAM (RTM) resonant acoustic mixer for 5 minutes at 80 g operating at 58-62 Hz. The mixed powder was then transferred to a static furnace and calcined in CO₂-free air using a temperature profile of (i) heating to 450° C. at a rate of 5° C./min; (ii) 450° C. for I hour; (iii) heating to 700° C. at a rate of 2° C./min; (iv) 700° C. for 2 hours; (v) allow to cool to ambient temperature.

ICP-MS analysis indicated that the material formed has a composition of Li_{1.01}Ni_{0.867}Co_{0.115}Mg_{0.012}Al_{0.006}O₂. X-ray powder diffraction (XRD) of the material produced showed crystalline material with a layered α-NaFeO₂-type structure.

### Example 7

### Method of Producing a Surface-Modified Lithium Nickel Metal Oxide Material of Formula Li_{1.01}Ni_{0.867}Co_{0.115}Mg_{0.012}Al_{0.006}O₂

Base material A (50 g) was placed into a plastic container with aluminium nitrate nonahydrate (1.22 g) and lithium nitrate (0.94 g). The materials were mixed using a LabRAM (RTM) resonant acoustic mixer for 5 minutes at 80 g operating at 58-62 Hz. The mixed powder was then transferred to a static furnace and calcined in CO₂-free air using a temperature profile of (i) heating to 450° C. at a rate of 5° C./min; (ii) 450° C. for 1 hour; (iii) heating to 700° C. at a rate of 2° C./min; (iv) 700° C. for 2 hours; (v) allow to cool to ambient temperature.

ICP-MS analysis indicated that the material formed has a composition of Li_{1.01}Ni_{0.867}Co_{0.115}Mg_{0.012}Al_{0.006}O₂. X-ray powder diffraction (XRD) of the material produced showed crystalline material with a layered α-NaFeO2-type structure.

### Example 8

### Electrochemical Testing

The samples from Examples 2 to 7 were electrochemically tested using the protocol set out below.

Electrochemical Protocol

The electrodes were prepared by blending 94%wt of the lithium nickel metal oxide active material, 3%wt of Super-C as conductive additive and 3%wt of polyvinylidene fluoride (PVDF) as binder in N-methyl-2-pyrrolidine (NMP) as solvent. The slurry was added onto a reservoir and a 125 μm doctor blade coating (Erichsen) was applied to aluminium foil. The electrode was dried at 120° C. for 1 hour before being pressed to achieve a density of 3.0 g/cm³. Typically, loadings of active is 9 mg/cm². The pressed electrode was cut into 14 mm disks and further dried at 120° C. under vacuum for 12 hours.

Electrochemical test was performed with a CR2025 coin-cell type, which was assembled in an argon filled glove box (M Braun). Lithium foil was used as an anode. A porous polypropylene membrane (Celgard 2500) was used as a separator. 1M LiPF₆ in 1:1:1 mixture of ethylene carbonate (EC), dimethyl carbonate (DMC) and ethyl methyl carbonate (EMC) with 1% of vinyl carbonate (VC) was used as electrolyte.

The cells were tested on a MACCOR 4000 series using C-rate and retention tests using a voltage range of between 3.0 and 4.3V. The C-rate test charged and discharged cells between 0.1C and 5C (0.1C=200mAh/g) at 23° C. The retention test was carried out at 1C with samples charged and discharged over 50 cycles at 23° C. or 45° C.

Electrochemical Results

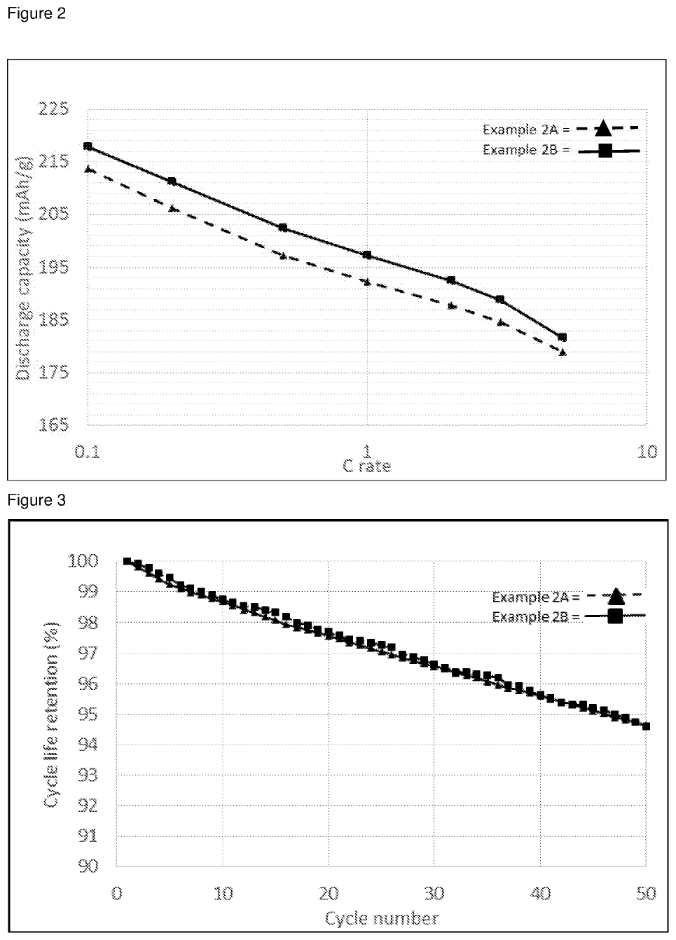

FIG. 2 shows the results of a C-rate test of the material produced in Example 2A and Example 2B at 23° C. This data shows that the both samples have a high initial discharge capacity with the material produced by Example 2B (mixed at 5 minutes at 60 g) having a higher initial capacity (217 mAh/g) than that of Example 2A (213 mAh/g).

FIG. 3 shows the results of cycle life retention testing of the material produced in Example 2A and Example 2B at 23° C. This shows that the both samples have a retention of >94% after 50 cycles.

In comparison, the material produced in Example 4 was assessed in a cycle life retention test at 23° C. The retention after 50 cycles was found to be 92% which indicates that a method involving acoustic mixing provides material with an improved cycle life in comparison with dry mixing.

The material produced in Example 2B was also electrochemically tested at 23° C. and 45° C. alongside three samples (Reference samples 1 to 3) of lithium nickel metal oxide material with a target composition matching that of Example 2B but produced by an immersion-spray dried method analogous to that described in WO2013025328 (Base Material A added to an aqueous mixture of cobalt (II) nitrate hexahydrate, aluminium nitrate nonahydrate and lithium nitrate followed by spray drying and calcination using the calcination conditions described in Example 2A). The results are shown in Table 2A and Table 2B. This data shows that comparable electrochemical performance has been achieved using the methods as described herein in comparison to prior art methods.

TABLE 2A
Electrochemical testing data at 23° C. showing first cycle charge (FCC) and
first cycle discharge (FCD) capacities, first cycle efficiency (Eff), and discharge
capacities at different discharge rates (0.1 C to 2 C) from a C-rate test.

| | Testing at 23 C. | | | | | | | |
|---|---|---|---|---|---|---|---|---|
| | FCC | FCD | Eff | 0.1 C | 0.2 C | 0.5 C | 1 C | 2 C |
| | (mAh/g) | (mAh/g) | (%) | (mAh/g) | (mAh/g) | (mAh/g) | (mAh/g) | (mAh/g) |
| Example 2B | 236 | 211 | 89 | 212 | 212 | 205 | 197 | 192 |
| Reference | 236 | 211 | 90 | 214 | 214 | 207 | 197 | 191 |
| sample 1 | | | | | | | | |
| Reference | 238 | 214 | 90 | 216 | 216 | 209 | 199 | 193 |
| sample 2 | | | | | | | | |
| Reference | 235 | 213 | 91 | 216 | 216 | 209 | 200 | 195 |
| sample 3 | | | | | | | | |

TABLE 2B
Discharge capacity retention testing data at 45° C.

| | Testing at 45 C. | | |
|---|---|---|---|
| | | | Retention (%) |
| | 1 C (1st) | 1 C(50^{th}) | after 50 cycles |
| Example | 207 | 175 | 85 |
| 2B | | | |
| Reference | 209 | 183 | 87 |
| sample 1 | | | |
| Reference | 209 | 173 | 83 |
| sample 2 | | | |
| Reference | 212 | 188 | 88 |
| sample 3 | | | |

The materials produced in Example 3 were also electrochemically tested. The results are shown in Table 3.

TABLE 3
The results of electrochemical testing
of the materials produced in Example 3.

| | | Retention after 50 cycles (45° C.) |
|---|---|---|
| Sample | 1 C (45° C.) mAh/g | % |
| 3A | 208 | 91 |
| 3B | 207 | 88 |
| 3C | 208 | 89 |
| 3D | 208 | 89 |
| 3E | 208 | 88 |

The data in Table 3 shows that comparable electrochemical results may be achieved using a variety of acoustic mixing power conditions and mixing times.

The materials produced in Examples 5, 6 and 7 were electrochemically tested alongside comparative materials (i) a sample of Base Material A produced according to the method of Example 1; and (ii) a reference sample of lithium nickel metal oxide material with a target composition matching that of Example 5A-5C but produced by an immersion-spray dried method analogous to that described in WO2013025328 (Base Material A added to an aqueous mixture of cobalt (II) nitrate hexahydrate, aluminium nitrate nonahydrate and lithium nitrate followed by spray drying and calcination using the calcination conditions described in Example 5). The data is provided in Table 4. With regards to discharge capacity retention the results indicate that each of the surface-modification methods (Reference Sample 4 and Examples 5-7) provides an improvement in discharge capacity retention with respect to the base material, in particular surface-modification using a cobalt-containing compound. With regards to discharge capacity, each of the surface-modified materials produced during the method as described herein shows an increase in discharge capacity at low and high discharge rates in comparison with Reference Sample 4. The material obtained in Example 6 shows the highest discharge capacities at 0.1 C and 5 C.

TABLE 4
The results of electrochemical testing of the
materials produced in Examples 5, 6 and 7.

| | C-Rate test values | | Cycle life (retention) values | | |
|---|---|---|---|---|---|
| | Discharge | Discharge | Discharge | Discharge | |
| | capacity | capacity | capacity | capacity | |
| | 0.1 C | 5 C | cycle 1 | cycle 50 | Retention |
| Sample | (mAh/g) | (mAh/g) | (mAh/g) | (mAh/g) | (%) |
| Base | 212.13 | 175.28 | 194.25 | 178.37 | 91.8 |
| Material A | | | | | |
| Reference | 209.31 | 175.95 | 192.12 | 181.68 | 94.6 |
| sample 4 | | | | | |
| Example 5A | 215.41 | 179.53 | 195.30 | 183.52 | 94.0 |
| Example 5B | 215.87 | 180.13 | 195.26 | 184.10 | 94.3 |
| Example 5C | 217.14 | 182.04 | 196.13 | 184.36 | 94.0 |
| Example 6 | 218.88 | 184.78 | 197.00 | 185.71 | 94.3 |
| Example 7 | 215.29 | 182.98 | 195.60 | 181.03 | 92.5 |

1-23 (canceled)

24. A process for producing a surface-modified particulate lithium nickel metal oxide material having a composition according to Formula 1:
LiₐNiₓM_{y}A_{z}O_{2+b} Formula 1
in which:
M is one or more of Co and Mn;
A is one or more of Al, V, Ti, B, Zr, Cu, Sn, Cr, Fe, Ga, Si, Zn, Mg, Sr, and Ca;
0.8≤a≤1.2
0.5≤x<1
0<y≤0.5
0≤z≤0.2
−0.2≤b≤0.2
x+y+z=1
the process comprising the steps of:
(i) providing lithium nickel metal oxide particles in the form of secondary particles comprising a plurality of primary particles separated by grain boundaries;
(ii) dry mixing the lithium nickel metal oxide particles with at least one metal-containing compound using acoustic energy;
(iii) calcining the mixture at a temperature of less than or equal to 800° C. to form the surface-modified particulate lithium nickel metal oxide material.

25. The process according to claim 24 wherein the concentration of at least one metal selected from the group of M and A at the grain boundaries of the surface-modified particulate lithium nickel metal oxide material is greater than the concentration of the metal at the grain boundaries of the lithium nickel metal oxide particles prior to the mixing and calcination steps.

26. The process according to claim 24 wherein A is Al and/or Mg.

27. The process according to claim 24 wherein M includes Co and the lithium nickel metal oxide particles are mixed with a cobalt-containing compound, preferably cobalt nitrate.

28. The process according to claim 27 wherein the concentration of cobalt at the grain boundaries of the surface-modified particulate lithium nickel metal oxide is greater than the concentration of cobalt in the primary particles of the surface-modified particulate lithium nickel metal oxide material.

29. The process according to claim 24 wherein A includes Al and the lithium nickel metal oxide particles are mixed with an aluminium-containing compound, preferably aluminium nitrate.

30. The process according to claim 29 wherein the concentration of aluminium at the grain boundaries of the surface-modified particulate lithium nickel metal oxide is greater than the concentration of aluminium in the primary particles of the surface-modified particulate lithium nickel metal oxide.

31. The process according to claim 24 wherein the lithium nickel metal oxide particles are mixed with a lithium-containing compound, preferably lithium nitrate.

32. The process according to claim 24 wherein M is Co.

33. The process according to claim 24 wherein each metal-containing compound is a metal salt, such as an inorganic metal salt.

34. The process according to claim 33 wherein each metal salt is a metal nitrate.

35. The process according to claim 24 wherein the mixing is carried out at an acceleration of 30 g to 100 g.

36. The process according to claim 24 wherein the mixing is performed by applying the acoustic energy for a period of between 1 and 10 minutes.

37. The process according to claim 24 wherein the acoustic energy has a frequency of about 15 Hz to about 1000 Hz, preferably about 15 Hz to about 100 Hz.

38. The process according to claim 24 wherein the dry mixing is mixing by acoustic resonance.

39. The process according to claim 24 wherein the calcination comprises the step of heating the mixture to a temperature of 400 to 800° C.,
optionally wherein the mixture is held at a temperature of 400° C. to 800° C. for a period of from 30 minutes to 8 hours.

40. The process according to claim 24 wherein the calcination comprises the step of heating the mixture to a temperature of 600° C. to 800° C.,
optionally wherein the mixture is held at a temperature of 600° C. to 800° C. for a period of from 30 minutes to 8 hours.

41. The process according to claim 24 wherein the mixture is calcined at a temperature of less than or equal to 750° C., or of less than or equal to 700° C.

42. The process according to claim 24 wherein the process comprises the step of milling the surface-modified particulate lithium nickel metal oxide material after the calcination step.

43. The process according to claim 24 further comprising the step of forming an electrode comprising the surface-modified particulate lithium nickel metal oxide material,
optionally wherein the process further comprises the step of constructing a battery or electrochemical cell including the electrode comprising the surface-modified particulate nickel metal oxide material.
